(19) United States
(12) Patent Application Publication
(10) Pub. No.: US 2007/0101849 A1
(43) Pub. Date: May 10, 2007

(54) Ball-lock punch retainer inserts

(76) Inventor: David J. Moellering, Orchard Lake, MI (US)

Correspondence Address: JAMES M. DEIMEN, 320 N. MAIN STREET, SUITE 300, ANN ARBOR, MI, 48104, US

(21) Appl. No.: 11/595,248

(22) Filed: Nov. 10, 2006

Related U.S. Application Data
(60) Provisional application No. 60/736,070, filed on Nov. 10, 2005.
(60) Provisional application No. 60/830,632, filed on Jul. 13, 2006.

(51) Int. Cl. B26D 7/26

(52) U.S. Cl. 83/698.11

(57) ABSTRACT

A ball-lock punch retainer insert comprises a tapered oblong or teardrop shape or an enlarged headed shape that completely encloses the punch hole or socket and the angle hole ball detent mechanism. The insert fits in a tapered oblong or teardrop hole or a counterbored hole formed in a block, the block in turn fastenable to a press platen. Tapered oblong or teardrop holes or counterbored holes can be easily formed in a hardened steel block as needed for immediate use. The ball-lock punch inserts can be inventoried for use as needed, thus, the combination provides for quick punch tooling and quick changes by forming new tapered oblong or teardrop holes or counterbored holes in the block.

This application claims the benefit of provisional patent application Nos. 60/736,070 and 60/830,632 filed Nov. 10, 2005 and Jul. 13, 2006, respectively.

### BACKGROUND OF THE INVENTION

The field of the invention pertains to retainers for industrial punches and, in particular, to ball-lock punch retainers. Ball-lock punch retainers utilize an offset ball detent and spring mechanism next to the punch socket in the retainer.

Examples of such retainers are the Accu-Lock™ special retainer inserts from Wilson Tool International, of White Bear Lake, Minn., and the True-Set® retainer from Moeller Manufacturing Co., of Plymouth, Mich. (U.S. Pat. Nos. 5,337,835, 5,410,932 and Des. 351,395).

With a view to providing a more versatile ball lock retainer for special purposes, the following retainer inserts have been developed.

### SUMMARY OF THE INVENTION

Die shops have begun using rectangular block punch retainers and re-drilling punch sockets as punch locations are changed with product changes. Unfortunately, such users cannot generally control the tolerances needed to make the punch retainers function properly.

To improve on the retainer systems available in industry, the new retainer inserts provide for a simplified and improved design to assist in manufacturing and to improve functionality, accuracy and cost. The first design incorporates a tapered oblong or teardrop insert that completely encloses the punch socket and angle hole ball detent associated with a standard ball-lock punch retainer. The second design incorporates a non-tapered oblong or teardrop insert with an enlarged head. This design also encloses the punch socket and angle hole ball detent associated with a standard ball-lock punch retainer.

There is a very critical relationship between the angle hole and the punch hole or socket. To ensure correct functionality, both holes must be manufactured to very tight tolerances. These improved insert designs incorporate both holes completely integrated into the insert and are therefore completely under the control of the insert manufacturer. Competing versions of the inserts rely upon the ability of the user or customer to provide the accuracy of the punch hole and insert combination. When manufacturing the ball-lock retainers, the punch hole and angle hole are precisely held to ten thousandths of an inch. Users and customers, like die shops, generally cannot control the tolerances as needed to make the product function properly.

The new insert designs also simplify the manufacture of the insert holder, allowing users the option to manufacture their own holder. The insert holder may be a simple block of low alloy steel with tapered or counterbored oblong or teardrop holes, which can easily be produced by wire electro-discharge machining (EDM) or computer numerically controlled (CNC) milling processes. The new insert designs have the benefit of speeding the process of moving a punch hole location, which often happens during die and holder construction. By simply using EDM or CNC machinery for a tapered or counterbored oblong or teardrop hole in a new location, a new punch location is established and the obsolete hole is abandoned. The machining can be done even if the holder or retainer is in a hardened condition.

The new insert design incorporates the Moeller patented one-piece punch hole design with its integrated backing support for the punch hole and angle hole and includes the snap ring ball and spring retention feature in the preferred embodiments. In addition to improved functionality is the benefit of improved lead time required to manufacture multi-punch holders or retainers. The new inserts can be inventoried ready for use and combined with custom built multi-tapered hole or multi-counterbored hole insert holders. Time is saved by eliminating the lengthy heat-treating step when manufacturing complete ball-lock retainers because blank insert holders can be also heat treated and inventoried.

Overall, the new inserts allow die shops to build their own stamping and punching details and still incorporate the ball-lock punch retention system. The ease and ability to do die and holder repair and alteration are improved, and lead time is improved.

### BRIEF DESCRIPTION OF THE DRAWINGS

FIG. 1 is a top plan view of the first tapered oblong insert;

FIG. 2 is a side cross-section of the first insert;

FIG. 3 is an end elevation of the first insert;

FIG. 4 is a top plan view of a rectangular block oblong tapered insert holder;

FIG. 5 is a side cross-section taken along the line 5-5 in FIG. 4;

FIG. 6 is a side cross-section of the first insert with a screw plug for the ball detent;

FIG. 7A is a side cross-section of an alternative first insert for use with a backing plate;

FIG. 7B is an end cross-section of the new insert of FIG. 7A;

FIG. 8 is a top plan view of an alternative first tapered teardrop insert;

FIG. 9 is a top plan view of a rectangular block tapered teardrop insert holder;

FIG. 10 is a top plan view of an alternate form of tapered teardrop insert;

FIG. 11 is a side cross-section of the teardrop insert of FIG. 10;

FIG. 12 is a side cross-section of the teardrop insert of FIG. 10 positioned in a modified insert holder;

FIG. 13 is a top plan view of an alternative headed teardrop insert;

FIG. 14 is a side view of the headed insert;

FIG. 15 is a perspective view of the headed insert;

FIG. 16 is a top plan view of a rectangular block counterbored teardrop insert holder; and

FIG. 17 is a side cross-section taken along the line 17-17 in FIG. 16.

### DESCRIPTION OF THE PREFERRED EMBODIMENTS

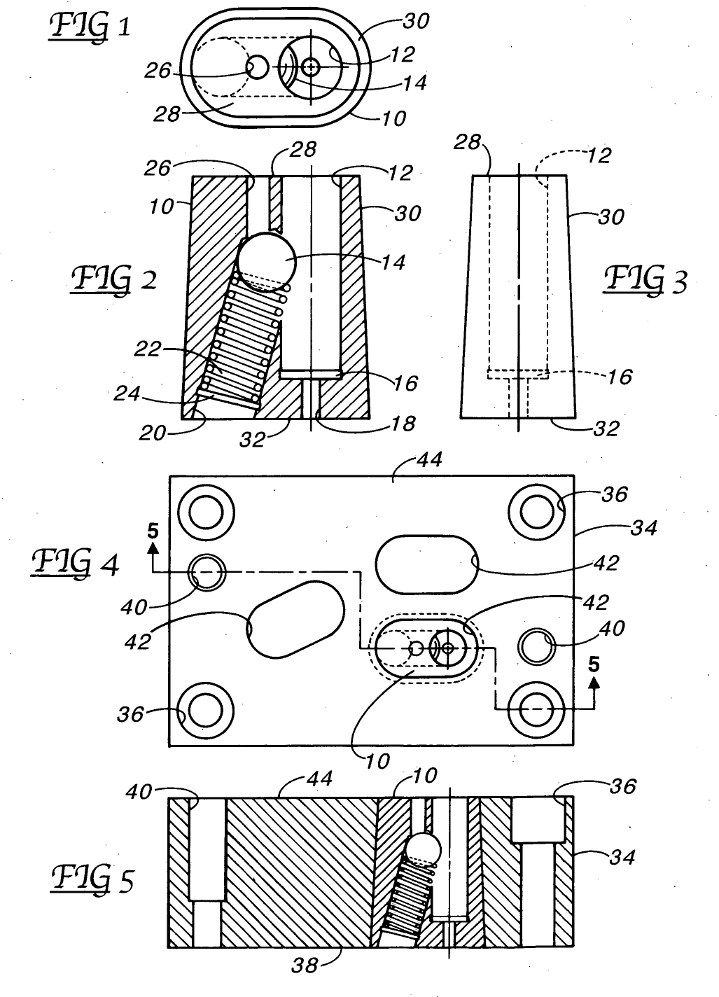

Illustrated in FIGS. 1, 2 and 3, the new oblong insert 10 has a punch hole or socket 12 and a ball detent 14 partially extending into the socket. The base of the socket 12 includes a counterbore 16 and dowel pin hole 18. An angle hole 20 encloses the ball detent 14, spring 22, and at the end of the spring remote from the ball a counterbore 24 for a snap ring (not shown) is provided. A relief hole 26 extends from the ball detent 14 to the top 28 of the insert 10. The sidewall 30 of the insert body is tapered about the entire insert 10 to provide a larger bottom 32 than top 30.

In FIGS. 4 and 5, a block retainer or holder 34 is of generally rectangular shape and formed with several bolt holes 36 for attachment of the bottom 38 in contact with a press platen (not shown). Also formed in the block 34 are dowel pin holes 40. Typically, the bolt holes 36 and dowel pin holes 40 are formed prior to heat treating of the block 34 and then finished for accuracy, if necessary, when the oblong holes 42 are formed by using EDM or CNC methods. The oblong holes 42 are tapered outwardly from the top 44 of the block 34 to the bottom 38, as best shown in FIG. 5, which shows an insert 10 in one of the tapered oblong holes. With the tapered insert 10 in the tapered hole 42 and the block 34 attached to a press platen, the press platen acts as a backing plate against the bottom 38 of the block thereby preventing the insert from loosening in the block and eliminating the need for a backing plate.

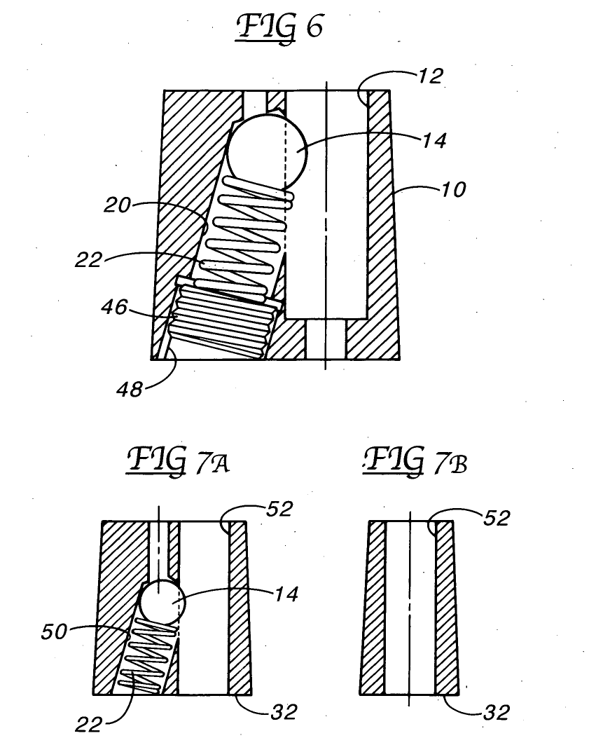

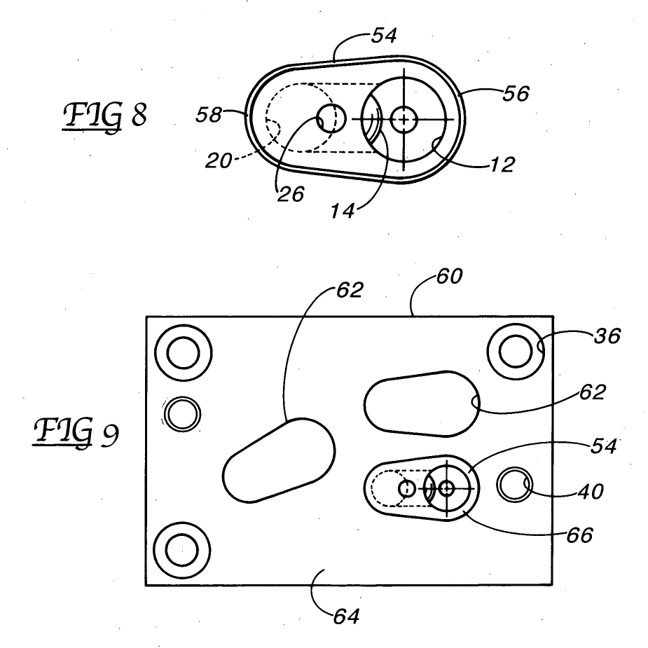

Illustrated in FIG. 6 is a modification of the insert 10 wherein a screw plug 46 is inserted in a threaded portion 48 of the angle hole 20. As with the snap ring above, the screw plug 46 provides a preset spring 22 compression for the ball detent 14. Where a backing plate is used on the holder, the angle hole 50 is not formed with a threaded portion or a counterbore and the spring 22 extends to the bottom 32 as shown in FIGS. 7A and 7B. The punch hole 52 extends fully through the insert 10. A holder and backing plate are further disclosed in FIG. 12.

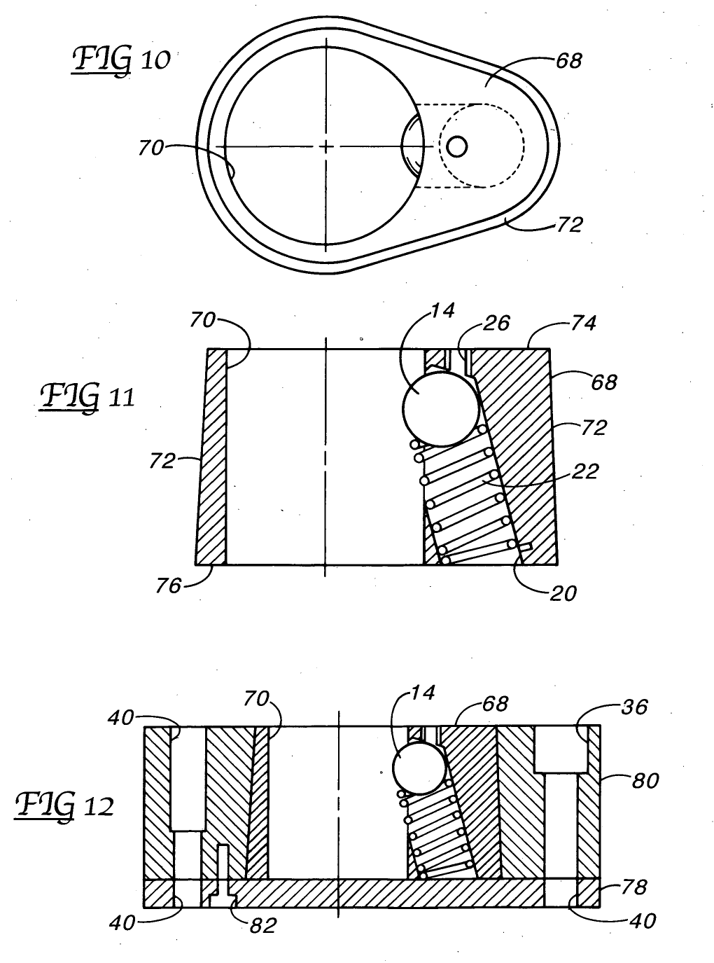

FIGS. 8 and 9 disclose a modification to the insert 54 comprising a teardrop shape in plan view. The end 56 of the insert 54 containing the socket 12 is larger as shown than the opposite end 58 containing the angle hole 20 for the ball detent 14. The sidewall of the insert 54 is tapered outwardly in the same manner as the sidewall of insert 10 resulting in a larger teardrop shape at the bottom of the insert 54.

Correspondingly, the insert holder 60 is formed with teardrop-shaped holes 62 that are tapered outwardly from the top 64 to the bottom. Thus, the teardrop-shaped insert 54 fits into the insert holder 60 with teardrop holes 62 in the same manner as shown at 66 as the oblong insert 10 fits into the insert holder 34. However, the teardrop configuration prevents any reverse insertion of the insert in the holder which can happen with the oblong insert in its holder.

FIGS. 10 and 11 illustrate a modification of the teardrop-shaped insert 68 wherein the socket 70 for a punch is a through hole and the ball 14 and spring 22 are only located in the angle hole 20. The insert 68 has a tapered sidewall 72 as above which extends outwardly from the top 74 to the bottom 76. To provide a seat for a punch and retain the ball 14 and spring 22 in the insert 68, a plate 78 covers the bottom 76 as shown in FIG. 12. The plate 78 is affixed to the insert holder 80 by a machine screw (not shown) in the counter-bored hole 82. The insert holder 80 includes bolt holes 36 and dowel pin holes 40, as above; however, the bolt holes and dowel pin holes penetrate the plate 78 for attachment to a platen or a press.

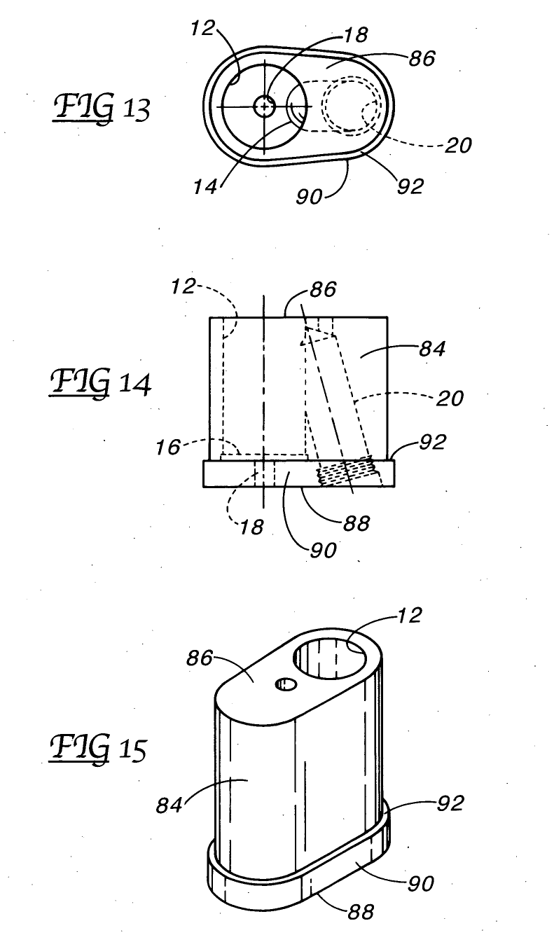

FIGS. 13, 14 and 15 illustrate the headed or enlarged head teardrop insert having the same punch hole or socket 12 and ball detent 14 partially extending into the socket. The base of the socket 12 includes a counterbore 16 and dowel pin hole 18. An angle hole 20 is provided for the ball detent and spring (not shown).

The sidewall 84 is perpendicular to the top 86 and bottom 88 of the insert. The bottom 88 of the insert is enlarged relative to the top 86 forming an enlarged portion or head 90 of the sidewall 84 adjacent the bottom and a peripheral shoulder 92 in the sidewall.

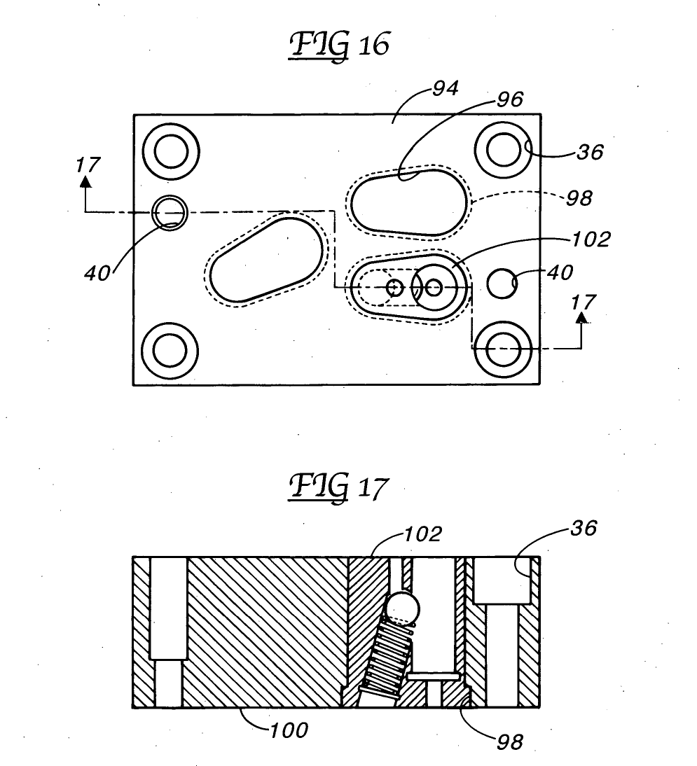

Illustrated in FIGS. 16 and 17 is a block retainer or holder 94 generally formed as in FIG. 4 but having insert teardrop-shaped holes 96 formed to accept the enlarged head teardrop insert of FIGS. 13, 14 and 15. As best shown in FIG. 17, the holes 96 are formed with a counterbore 98 in the bottom 100 of the holder 94 to lock in the enlarged head 90 insert 102 when the holder is fastened to a press platen.

1. A ball-lock punch retainer insert comprising an oblong shaped body having a punch socket adjacent one end of the body and an angle hole toward the other end of the body, the angle hole containing a ball detent mechanism and the punch socket intersecting the top of the body,
the improvement comprising a tapered side wall on the body, the taper extending outwardly toward the bottom of the body to provide an oblong shaped bottom of the body larger than the top of the body.

2. The ball-lock punch retainer insert of claim 1 wherein the tapered side wall extends completely about the body.

3. The ball-lock punch retainer insert of claim 1 wherein the tapered side wall extends from the top to the bottom of the body.

4. The ball-lock punch retain insert of claim 1 including an insert holder having an oblong tapered hole formed therethrough complementary to the insert.

5. A ball-lock punch retainer insert comprising a teardrop-shaped body having a punch socket adjacent one end of the body and an angle hole toward the other end of the body, the angle hole containing a ball detent mechanism and the punch socket intersecting the top of the body,
the improvement comprising a tapered sidewall on the body, the taper extending outwardly toward the bottom of the body to provide a teardrop-shaped bottom of the body larger than the top of the body.

6. The ball-lock punch retainer insert of claim 5 wherein the tapered sidewall extends completely about the body.

7. The ball-lock punch retainer insert of claim 5 wherein the tapered sidewall extends from the top to the bottom of the body.

8. The ball-lock punch retainer insert of claim 5 wherein the punch socket is adjacent a larger end of the body.

9. The ball-lock punch retainer insert of claim 5 including an insert holder having a teardrop-shaped tapered hole formed therethrough complementary to the insert.

10. A ball-lock punch retainer comprising a body having a punch socket adjacent one end of the body and an angle hole toward the other end of the body, the angle hole intersecting the punch socket, a ball detent and a spring in engagement with the ball detent,
the improvement comprising a thread formed in a wall of the angle hole at a location remote from the ball detent and a screw plug in engagement with the spring, whereby the screw plug retains the spring and ball detent in the angle hole.

11. A ball-lock punch retainer insert comprising a teardrop-shaped body having a punch socket adjacent one end of the body and an angle hole toward the other end of the body, the angle hole containing a ball detent mechanism and the punch socket intersecting a top on the body,
the improvement comprising a sidewall on the body perpendicular to the top on the body and a bottom on the body larger than the top and perpendicular to the sidewall, said sidewall being formed with a shoulder spaced from the top and the bottom.

12. The ball-lock punch retainer insert of claim 11 wherein the punch socket is adjacent a larger end of the body.

13. The ball-lock punch retainer insert of claim 11 including an insert holder having a teardrop-shaped hole formed therethrough with a shoulder in a side wall of the teardrop-shaped hole complementary to the insert sidewall.

14. A ball-lock punch retainer insert comprising a teardrop-shaped body having a punch socket adjacent one end of the body and an angle hole toward the other end of the body, the angle hole containing a ball detent mechanism and the punch socket intersecting the top of the body,
the improvement comprising means extending outwardly beyond a sidewall of the body and adapted to engage complementary means in a holder for the insert.

15. The ball-lock punch retainer insert of claim 14 including an insert holder having a teardrop-shaped hole formed therethrough with an indentation in a sidewall of the teardrop-shaped hole complementary to the means extending outwardly beyond a sidewall of the insert body.
